(19) United States
(12) Patent Application Publication
(10) Pub. No.: US 2024/0249208 A1
(43) Pub. Date: Jul. 25, 2024

(54) INFORMATION PROCESSING DEVICE

(71) Applicant: TOYOTA JIDOSHA KABUSHIKI KAISHA, Toyota-shi (JP)

(72) Inventors: Nariaki AMANO, Nagoya-shi (JP); Yukinori II, Toyota-shi (JP); Yusuke MAEDA, Miyota-shi (JP); Takeshi MURAKAMI, Okazaki-shi (JP); Atsuki SAKURAI, Toyota-shi (JP); Yuichiro YANO, Nagakute-shi (JP); Yuki KATAI, Toyota-shi (JP); Yoshiaki SUGIYAMA, Anjo-shi (JP); Taisei NISHIMORI, Okazaki-shi (JP); Seiichi TAGAWA, Nagoya-shi (JP); Shinichi TAKEDA, Nagoya-shi (JP); Yuta TONE, Nagoya-shi (JP)

(73) Assignee: TOYOTA JIDOSHA KABUSHIKI KAISHA, Toyota-shi (JP)

(21) Appl. No.: 18/533,610

(22) Filed: Dec. 8, 2023

(30) Foreign Application Priority Data
Jan. 25, 2023 (JP) 2023-009469

(51) Int. Cl. G06Q 10/02; G06Q 10/20

(52) U.S. Cl. CPC G06Q 10/02; G06Q 10/20

(57) ABSTRACT

An information processing device includes a control unit that executes: obtaining a request to add an item to a vehicle; obtaining first information that is information depending on whether the vehicle has a structure for adding an item; determining a factory that provides a service for adding the item to the vehicle based on the first information and information about the item; and outputting information about the factory.

### CROSS-REFERENCE TO RELATED APPLICATION

This application claims priority to Japanese Patent Application No. 2023-009469 filed on Jan. 25, 2023, incorporated herein by reference in its entirety.

### BACKGROUND

### 1. Technical Field

The present disclosure relates to an information processing device.

### 2. Description of Related Art

It is disclosed that there is no need for complicated wiring by integrating a device that detects following vehicles with a global positioning system (GPS) unit, and a user can extremely easily install and use the device just by attaching the device to a rear glass on a vehicle cabin side and inserting a car plug into a power socket (see, for example, Japanese Unexamined Patent Application Publication No. 2022-151444 (JP 2022-151444 A)).

### SUMMARY

An object of the present disclosure is to present a suitable factory in which retrofit items can be added.

An information processing device according to an aspect of the present disclosure includes a control unit that executes:
acquiring a request for adding an item to a vehicle;
acquiring first information that is information according to whether the vehicle has a structure for adding the item;
determining a factory that provides a service for adding the item to the vehicle based on the first information and information about the item; and
outputting information about the factory.

Further, another aspect of the present disclosure provides an information processing method in which a computer executes processes in the above information processing device, a program for causing a computer to execute the processes in the above information processing device, and a storage medium that stores the program in a non-transitory manner.

According to the present disclosure, it is possible to present a suitable factory in which retrofit items can be added.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a schematic configuration of a system according to an embodiment;

FIG. 2 is a block diagram schematically showing an example of the configuration of each of a user terminal, a center server, and a work factory server that constitute the system according to the embodiment;

FIG. 3 is a diagram exemplifying the functional configuration of the center server;

FIG. 4 is a diagram illustrating table configurations of the vehicle information DB and the item information DB.

FIG. 5 is a diagram exemplifying the table configuration of the factory information DB; and

FIG. 6 is a flowchart of processing in the center server according to the embodiment.

### DETAILED DESCRIPTION OF EMBODIMENTS

There is a technology for retroactively adding a function or part (hereinafter also referred to as an item) to a vehicle. For example, it is conceivable to retrofit a blind spot monitor (BMS) that detects vehicles approaching from the rear side of the vehicle. In such cases, it is necessary to add sensors to the rear of the vehicle. Additionally, a wire harness with a connector that connects to the sensor is required to send the output of the sensor to a control unit (ECU). However, if the existing wire harness does not have a connector, the wire harness needs to be replaced. In order to replace the wire harness, it is necessary to temporarily remove the interior parts, resulting in a long working time. Also, when adding a sensor, it may be necessary to drill a hole in the vehicle in order to attach the sensor itself to the vehicle, or it may be necessary to attach a bracket to fix the connector connected to the sensor. Such work also takes time.

On the other hand, it is conceivable to arrange in advance a wire harness having a connector for connecting to the sensor, for example, so as to facilitate attachment of the retrofitted part. Then, for example, it becomes possible to easily install retrofit items at a factory attached to an automobile dealership. On the other hand, if a wire harness that supports retrofit items is not attached to the vehicle, drilling holes in the vehicle body, welding, or sheet metal work may be required, and the vehicle must be stocked in the factory that can perform more advanced work. Therefore, since the factory that performs the work of adding items may differ depending on the vehicle, it may be difficult to determine in which factory the work should be performed.

Therefore, an information processing device, which is one aspect of the present disclosure, includes a control unit that executes: obtaining a request to add an item to a vehicle; obtaining first information that is information depending on whether the vehicle has a structure for adding an item; determining a factory that provides a service for adding the item to the vehicle based on the first information and information about the item; and outputting information about the factory.

Items are devices, parts or systems that can be retrofitted to a vehicle. A request to add an item to the vehicle is sent, for example, from the user's terminal. This user's terminal may be the terminal of the owner of the vehicle, or the terminal of a car dealership or the like. The information according to whether the vehicle has a structure for adding items, which is included in the first information, is information regarding whether the vehicle has a structure for adding items. This structure contains information as to whether the vehicle has a wiring harness that can be connected to the item. If such a wire harness is preliminarily attached to the vehicle, it can be said that the vehicle has a structure that assumes retrofitting of the item. Information may also include, for example, whether the vehicle has holes for mounting parts, depending on whether the vehicle has a structure for adding items. The information according to whether the vehicle has a structure for adding items may be, for example, information linked to the vehicle body number, vehicle type, vehicle grade, vehicle model, and the like.

The control unit then determines the factory that provides the service of adding the item to the vehicle. The factory that provides the service of adding this item to the vehicle is the factory that attaches the item to the vehicle on behalf of the user. Here, it is conceivable that the factories that can add items are different depending on whether the vehicle has a structure for adding items or not. Also, depending on the item to be added, the factory that can add the item may differ. Therefore, the control unit determines the appropriate factory based on the first information and the information regarding the item. Furthermore, the control unit outputs information about the determined factory. By outputting the information about the factory to the user's terminal, for example, the factory can be notified to the user. Information about the factory may also be output, such as placing an order for items to be added to the factory.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

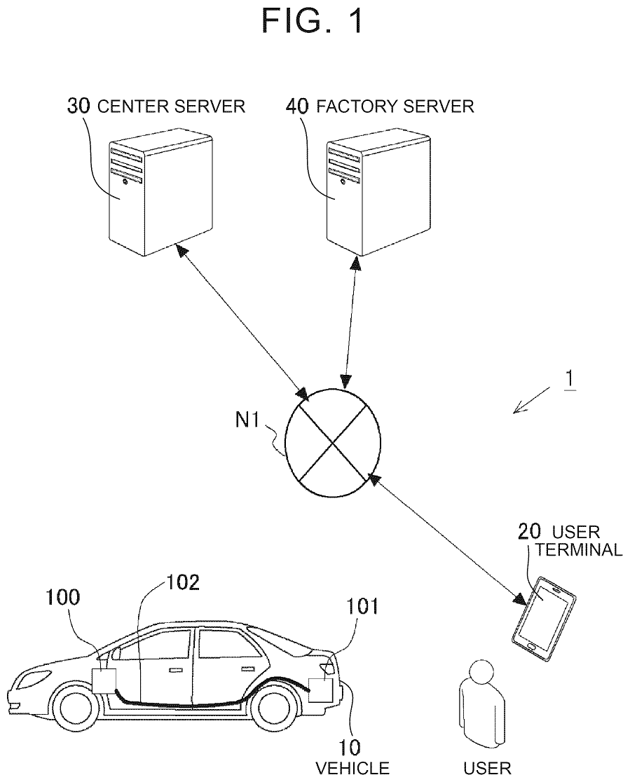

FIG. 1 is a diagram illustrating a schematic configuration example of a system 1 according to an embodiment of the present disclosure. In the example of FIG. 1, the system 1 includes a terminal 20 of a user of the vehicle 10 (hereinafter referred to as user terminal 20), a center server 30, and a factory server 40. A vehicle 10 is equipped with an in-vehicle device 100. Items can be added to the vehicle 10. For example, sensor 101 is retrofitted when adding a blind spot monitor (BSM). The BSM is a system that detects the approach of another vehicle from behind and supports the user's decision when changing lanes. The sensor 101 in this case is, for example, a radar sensor. Sensor 101 is connected to in-vehicle device 100 via wire harness 102. The in-vehicle device 100 executes installed software to control the vehicle 10 and the BSM. The user terminal 20 is a terminal used by a user associated with the vehicle 10.

The center server 30 accepts addition of items to the vehicle 10 from the user terminal 20. Then, the center server 30 determines a factory that provides the service of adding items to the vehicle 10 based on the structure of the vehicle 10 and the item. This factory is a factory for adding items. The center server 30 also outputs a command to display the determined factory on the user terminal 20, orders parts so that the parts are sent to the determined factory, and reserves the determined factory available to the user. The factory server 40 is a server that manages a factory (also referred to as a work factory) that performs work for adding items. Note that there may be a plurality of work factories. The factory server 40 may be arranged for each work factory. The factory server 40 manages work vacant times and accepts reservations for additional work for items.

Here, the work of adding items in the present disclosure will be described. Vehicle 10 can be retrofitted or replaced with, for example, blind spot monitors (BSM), safety features, parking support brakes (PKSB), panoramic view monitors (PVM), steering heaters, seat upholsteries, and the like. BSM is a system that detects the approach of another vehicle from behind as described above and assists the user in making a decision when changing lanes. In order to add BSM functionality to the vehicle 10, a wire harness 102 having a sensor 101 and a connector connectable to the sensor 101 is required. In addition, it is necessary to replace the side mirrors, bumpers, etc. with those compatible with BSM. A bracket may be required for mounting the sensor 101 or mounting a connector connected to the sensor 101. Safety features are packages that include, for example, Front Cross Traffic Alert (FCTA), Lane Change Assist (LCA), Emergency Steering Assistance, and more. FCTA is a function that detects vehicles approaching from the left and right when entering an intersection. The LCA is a function that assists steering when changing lanes and monitoring of vehicles ahead of the lane change. In order to add a safety function, it is necessary to add a sensor, replace the steering wheel, etc., and furthermore, wire harness 102 corresponding to these parts is required.

PKSB is a system that issues a warning and collision damage mitigation brake control when an object to be activated is detected during low-speed driving such as parking. A rearview camera and corresponding wire harness 102 are required to add PKSB functionality. The PVM is a function of connecting images from cameras attached to the front, rear, left, and right of the vehicle 10, generating an image of the surroundings of the vehicle 10, and displaying the image on a display. In order to add PVM functionality, it is necessary to add a camera and control unit (ECU), and to replace the front grille and side mirrors. Also, a wire harness 102 corresponding to these parts is required.

The steering heater is a function that warms the steering wheel. In order to add the function of the steering heater, it is necessary to replace the steering wheel and add a switch. Also, a wire harness 102 corresponding to these parts is required. For the seat upholstery, it may be possible, for example, to replace it with a premium fabric and add a seat heater. Replacing with high-grade fabric is to change the seat covering to a higher-grade one. The seat heater has a function of warming the skin of the seat. Seat replacement and air conditioner controller replacement are required. Also, a wire harness 102 corresponding to these parts is required.

It is conceivable to design the vehicle 10 in advance so that such items can be easily added. For example, since it takes time to replace the wire harness 102 after the fact, it is conceivable to arrange the wire harness 102 corresponding to the item in advance or to open a hole for attaching the sensor in advance. Then you can add items with relatively simple work. On the other hand, there may be vehicles that are not designed in this way. For example, if an item has not been developed when the vehicle 10 is manufactured, it is difficult to arrange the wire harness 102 corresponding to the item in advance. In such cases, laborious work is required to add the item, and the item must be installed at a factory with appropriate equipment. In other words, a vehicle that is designed to correspond to an item and a vehicle that is not designed for that item may have different factories for adding the item. Therefore, the center server 30 determines the factory where the work is to be performed according to the vehicle 10 and the item.

The user terminal 20, center server 30, and factory server 40 are interconnected by a network N1. The network N1 is, for example, a worldwide public communication network such as the Internet, and may be a Wide Area Network (WAN) or other communication networks. In addition, the network N1 may include a telephone communication network such as a mobile phone network and a wireless communication network such as Wi-Fi (registered trademark). Although one vehicle 10 and one user terminal 20 are illustrated in FIG. 1 as an example, multiple vehicles 10 and user terminals 20 may exist.

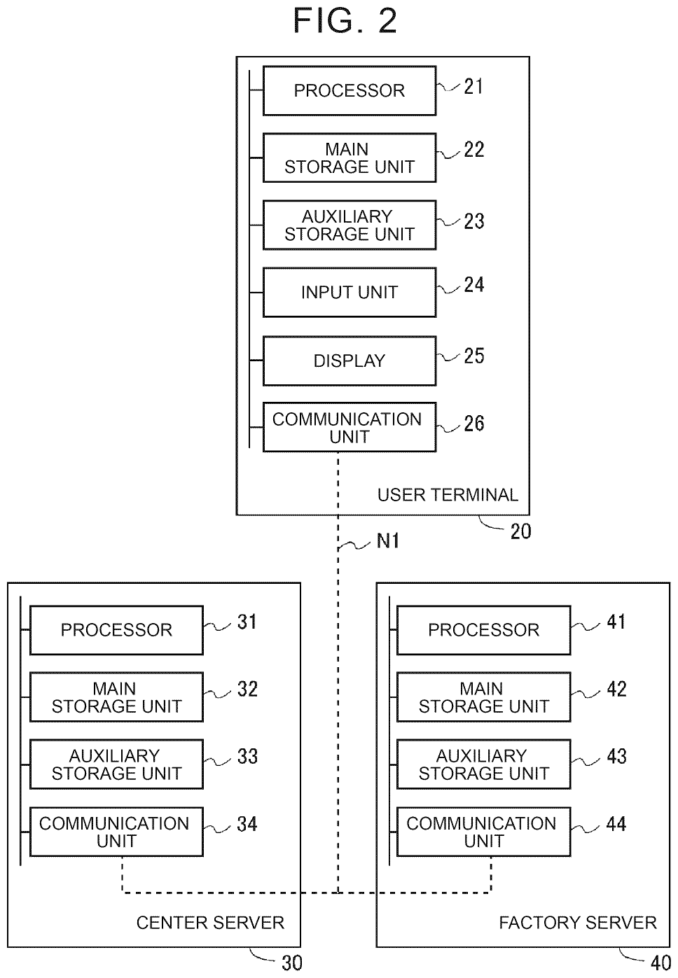

Based on FIG. 2, the hardware configuration and functional configuration of the user terminal 20, the center server 30, and the factory server 40 will be described. FIG. 2 is a block diagram schematically showing an example of configuration of each of the user terminal 20, the center server 30, and the factory server 40 that configure the system 1 according to the embodiment.

The center server 30 has a computer configuration. The center server 30 includes a processor 31, a main storage unit 32, an auxiliary storage unit 33, and a communication unit 34. The processor 31, main storage unit 32, auxiliary storage unit 33, and communication unit 34 are interconnected by a bus. The processor 31 is an example of a control unit.

The processor 31 is a Central Processing Unit (CPU), a Digital Signal Processor (DSP), or the like. The processor 31 controls the center server 30 and performs various information processing calculations. The main storage unit 32 is Random Access Memory (RAM), Read Only Memory (ROM), or the like. The auxiliary storage unit 33 is an Erasable Programmable ROM (EPROM), Hard Disk Drive (HDD), removable media, or the like. The auxiliary storage unit 33 stores an operating system (OS), various programs, various tables, and the like. The processor 31 loads the program stored in the auxiliary storage unit 33 into the work area of the main storage unit 32 and executes the program. Through execution of the program, each component is controlled. As a result, the center server 30 realizes the function that matches the predetermined purpose. The main storage unit 32 and the auxiliary storage unit 33 are computer-readable recording media.

The communication unit 34 is means for communicating with the user terminal 20 and the factory server 40 via the network N1. The communication unit 34 is, for example, a Local Area Network (LAN) interface board or a wireless communication circuit for wireless communication. The LAN interface board and the wireless communication circuit are connected to the network N1.

The factory server 40 has a computer configuration. The factory server 40 has a processor 41, a main storage unit 42, an auxiliary storage unit 43 and a communication unit 44. The processor 41, main storage unit 42, auxiliary storage unit 43, and communication unit 44 are interconnected by a bus. The processor 41, the main storage unit 42, the auxiliary storage unit 43, and the communication unit 44 are the same as the processor 31, the main storage unit 32, the auxiliary storage unit 33, and the communication unit 34 of the center server 30, and accordingly, description will be omitted.

Next, the user terminal 20 will be described. The user terminal 20 is, for example, a small computer such as a smart phone, a mobile phone, a tablet terminal, a personal information terminal, a wearable computer (such as a smart watch), or a Personal Computer (PC). The user terminal 20 has a processor 21, a main storage unit 22, an auxiliary storage unit 23, an input unit 24, a display 25 and a communication unit 26. The processor 21, main storage unit 22, auxiliary storage unit 23, input unit 24, display 25, and communication unit 26 are interconnected by a bus. The processor 21, the main storage unit 22, and the auxiliary storage unit 23 are similar to the processor 31, the main storage unit 32, and the auxiliary storage unit 33 of the center server 30, respectively, and thus the description thereof will be omitted.

The input unit 24 is a means for receiving an input operation performed by the user, and is, for example, a touch panel, a mouse, a keyboard, a push button, or the like. The display 25 is means for presenting information to the user, and is, for example, a Liquid Crystal Display (LCD) or an Electro Luminescence (EL) panel. The input unit 24 and the display 25 may be configured as one touch panel display. The communication unit 26 is a circuit that communicates with the center server 30, for example.

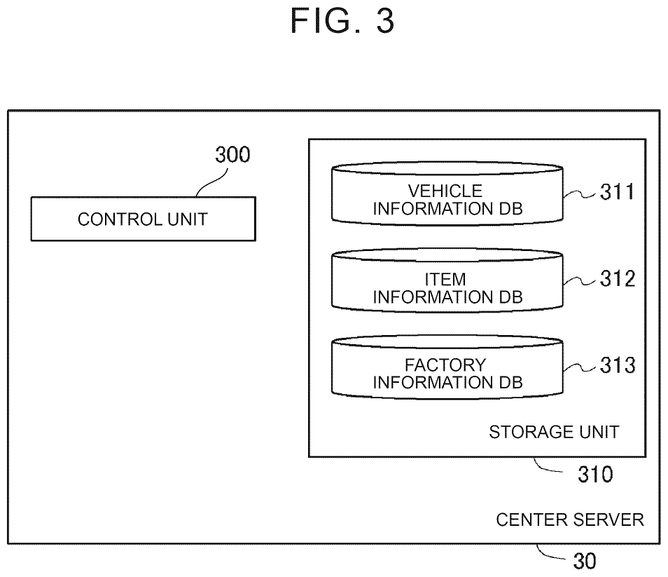

Next, the function of the center server 30 will be described. FIG. 3 is a diagram showing an example of a functional configuration of the center server 30. The center server 30 includes a control unit 300 and a storage unit 310 as functional components. The processor 31 of the center server 30 executes the processing of the control unit 300 according to the computer program on the main storage unit 32. Further, the storage unit 310 includes a main storage unit 32 and an auxiliary storage unit 33. Storage unit 310 stores databases such as vehicle information DB 311, item information DB 312, and factory information DB 313.

The control unit 300 receives a request to add an item to the vehicle 10 by interacting with the user terminal 20. The control unit 300 may generate a user interface screen for interacting with the user terminal 20. User interface screens may be generated using a built-in web server or the like. In this embodiment, for example, based on the identifier (vehicle ID) of the vehicle 10 received from the user terminal 20, the control unit 300 generates and provides a product list including items suitable for the vehicle 10. The control unit 300 then accepts a request to add the item specified by the user terminal 20.

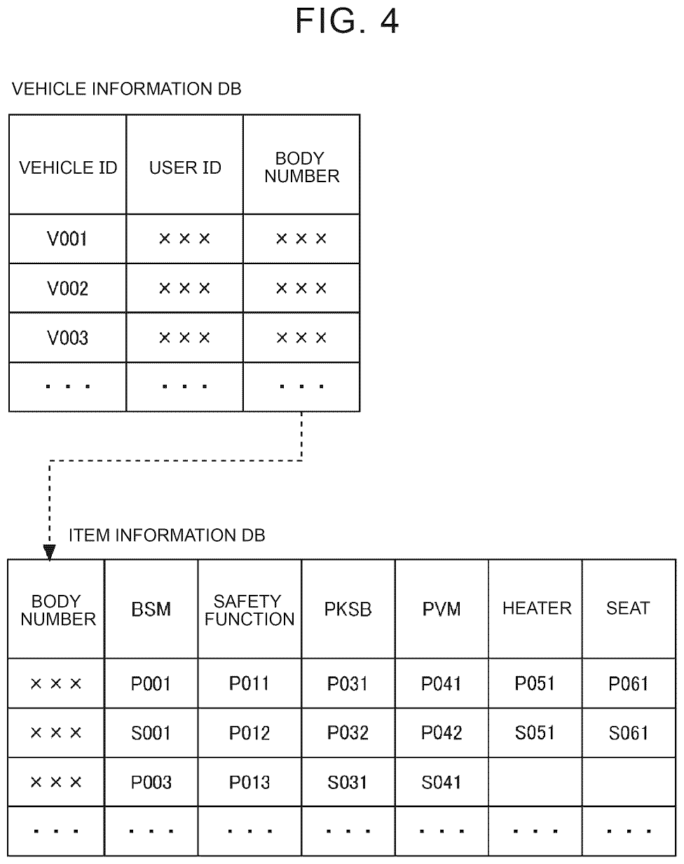

Here, configurations of vehicle information stored in the vehicle information DB 311 and item information stored in the item information DB 312 will be described with reference to FIG. 4. FIG. 4 is the figure which illustrated the table structure of vehicle information DB 311 and item information DB 312. The vehicle information table of the vehicle information DB 311 has fields of vehicle ID, user ID, and vehicle body number. Information (vehicle ID) that can identify the vehicle is entered in the vehicle ID field. A vehicle ID is assigned in advance to each vehicle 10. Information (user ID) that can identify a user associated with the vehicle 10, such as the user of the vehicle 10, is entered in the user ID field. The user ID may be information that can identify the user terminal 20. Information related to the vehicle body number of the vehicle 10 is entered in the vehicle body number field. In addition, since the vehicle body number is a number unique to the vehicle, the vehicle body number may be used as the vehicle ID. Information about items that can be added to the vehicle 10, such as the vehicle type, the grade of the vehicle 10, and the model year of the vehicle 10, may be stored instead of the vehicle body number.

Also, the item information table of the item information DB 312 has fields for body number, BSM, safety function, PKSB, PVM, heater, and seat. Information corresponding to the vehicle body number field of the vehicle information DB 311 is input to the vehicle body number field of the item information DB 312. The BSM, Safety Features, PKSB, PVM, Heaters, and Seat fields are populated with information depending on whether they have structure to add the respective item. The BSM, Safety Features, PKSB, PVM, Heaters, and Seat fields are populated with numbers starting with, for example, “P” if you have a structure to add items. The BSM, Safety Features, PKSB, PVM, Heater, and Seat fields are populated with numbers starting with an “S” if the item has no structure to be added, but the item can be retrofitted. The BSM, Safety Features, PKSB, PVM, Heater, and Seat fields will be blank if they have no structure to add items and cannot retrofit items. Also, the numbers entered in the respective fields are used when ordering necessary parts when adding items, for example. If a number starting with “P” is entered, it indicates that the wire harness 102 corresponding to the item is attached to the vehicle 10. Therefore, in this case, it is not necessary to replace the wire harness 102 even if the item is added. On the other hand, if a number starting with “S” is entered, it indicates that the wire harness 102 corresponding to the item is not attached to the vehicle 10. In this case, replacement of the wire harness 102 is required. Information stored in the item information DB 312 is an example of the first information.

Also, the control unit 300 determines whether or not the wire harness 102 to which the specified item can be added is provided based on the vehicle ID and the specified item. At this time, the control unit 300 refers to the vehicle information stored in the vehicle information DB 311 and the item information stored in the item information DB 312 to determine whether the wire harness 102 to which the designated item can be added is provided. Then, based on the determination result, the factory for adding the item is determined. The relationship between the determination result and the factory that performs the work of adding the item is stored in the factory information DB 313.

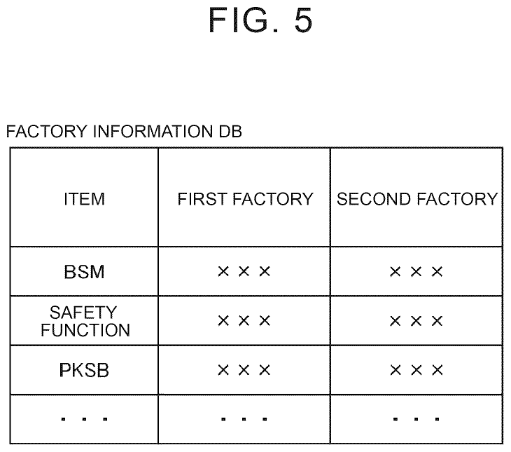

Here, FIG. 5 is a diagram exemplifying the table configuration of the factory information DB 313. The factory information table of the factory information DB 313 has fields for item, first factory, and second factory. Information corresponding to each item in the item information DB 312 is entered in the item field. If the vehicle 10 already has a structure corresponding to the item of each record, then the first factory field is entered with information regarding the factory where the item can be installed. For example, information is input for identifying a factory that can install the item to the vehicle 10 that has a structure that can add the retrofit item. This information may include information such as factory name, address, and phone number. The first factory is the factory that is selected when it is possible to add items to the vehicle 10 with relatively simple work. On the other hand, if the vehicle 10 does not have a structure corresponding to the item of each record, then the second factory field is entered with information regarding the factory where the item can be installed. For example, information is input to identify a factory that can install the item to the vehicle 10 that does not have a structure that can add the retrofit item. This information may include information such as factory name, address, and phone number. The second factory is the factory selected when adding items to the vehicle 10 requires relatively advanced work. Note that the factory information DB 313 may have a factory information table for each vehicle body number.

Also, the control unit 300 may reserve a factory for adding items. The control unit 300 inquires of the factory server 40 about the date and time when the reservation is possible, that is, when the work is possible. Then, when the control unit 300 acquires the date and time when the reservation is possible, the control unit 300 transmits the date and time when the reservation is possible to the user terminal 20 and allows the user to select the date and time. When the user terminal 20 designates the date and time, the control unit 300 reserves the work for the factory server 40.

Further, in response to the reservation of the work, the control unit 300 may order the parts so that the parts necessary for adding the item are sent to the reserved factory. This part is stored in the auxiliary storage unit 33 in association with the number stored in the item information DB 312.

Next, functions of the user terminal 20 will be described. The user terminal 20 has a control unit as a functional component. The processor 21 of the user terminal 20 executes the processing of the control unit according to the computer program on the main storage unit 22. The user terminal 20 is installed with an application program (hereinafter referred to as an application) for making a request to add an item.

The control unit of the user terminal 20 generates data for making a request to add an item according to the input to the input unit 24 of the user terminal 20. This data includes, for example, vehicle ID, user ID, and items to be added. For example, when the user activates an application installed in the user terminal 20 and inputs the vehicle ID, user ID, and item, a request for adding the item is generated and sent to the center server 30. Items that can be added according to the vehicle ID may be obtained from the center server 30 and displayed on the display 25. The control unit may then generate a request to add the item tapped by the user.

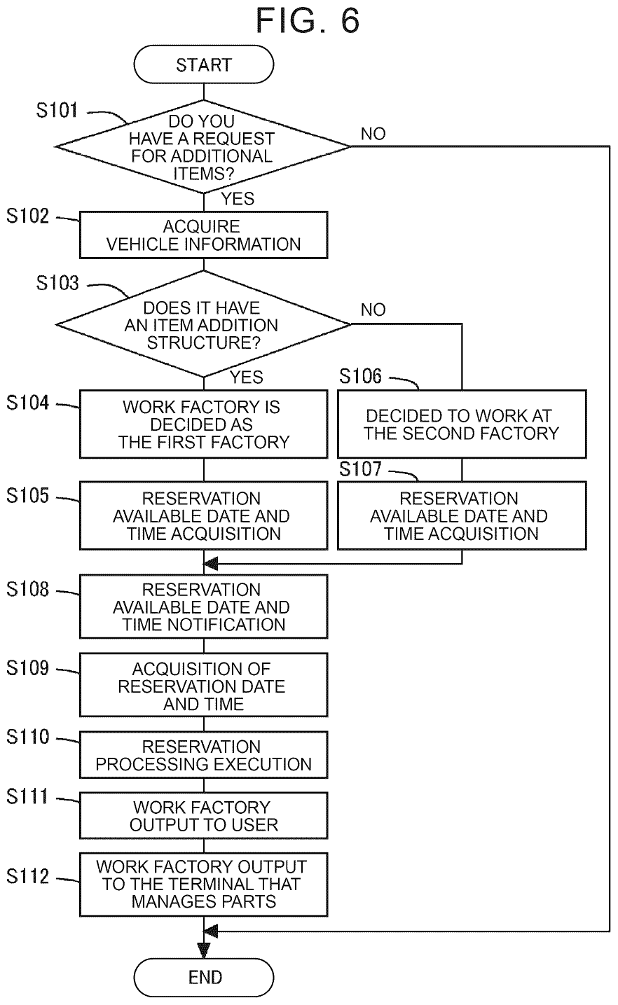

Next, the process in the center server 30 will be described. FIG. 6 is a flowchart of processing in the center server 30 according to the embodiment. The processing shown in FIG. 6 is executed in the center server 30 at predetermined time intervals. It is assumed that necessary information is already stored in each database. Also, in this routine, it is assumed that an item that is blank in the item information DB 312 cannot be selected by the user terminal 20.

In S101, the control unit 300 determines whether an item addition request has been received from the user terminal 20. If the determination in S101 is affirmative, the routine proceeds to S102, and if the determination is negative, the routine is terminated.

In S102, the control unit 300 acquires vehicle information from the vehicle information DB 311. The control unit 300 acquires vehicle information from the vehicle information DB 311 based on the vehicle ID or user ID included in the request from the user terminal 20. More specifically, the body number of the vehicle 10 is obtained. Alternatively, the user terminal 20 may transmit information on the vehicle body number. In this case, the vehicle information DB 311 can be omitted.

In S103, the control unit 300 determines whether the vehicle 10 has a structure capable of adding items (hereinafter also referred to as an item addition structure). The control unit 300 accesses the item information DB 312 and determines whether or not a product number starting with “P” is entered in the specified item field in the corresponding vehicle body number record. If the determination in S103 is affirmative, the process proceeds to S104, and if the determination is negative, the process proceeds to S106.

In S104, the control unit 300 determines the work factory to be the first factory. The control unit 300 refers to the factory information DB 313 and acquires information stored in the first factory field in the record corresponding to the designated item. In S105, the control unit 300 acquires information about available dates and times by inquiring of the factory server 40 corresponding to the first factory about available dates and times.

On the other hand, in S106, the control unit 300 determines the second factory as the work factory. The control unit 300 refers to the factory information DB 313 and acquires information stored in the second factory field in the record corresponding to the designated item. In S107, the control unit 300 obtains information about available dates and times by inquiring of the factory server 40 corresponding to the second factory about available dates and times.

In S108, the control unit 300 notifies the user terminal 20 of the reservation available date and time. At this time, the control unit 300 may generate and transmit a command to display a list of available dates and times on the display 25 of the user terminal 20. Next, in S109, the control unit 300 acquires the reservation date and time from the user terminal 20. The user terminal 20 acquires the date and time tapped by the user from among the available dates and times displayed on the display 25. The processor 21 of the user terminal 20 transmits the acquired information regarding the date and time to the center server 30.

In S110, the control unit 300 executes reservation processing so as to reserve the work factory at the acquired reservation date and time. In the reservation process, the reservation process is performed by transmitting information regarding the date and time of reservation, vehicle ID, user ID, items to be added, etc. to the factory server 40. At this time, information about the name, telephone number, e-mail address, etc. of the user associated with the user ID may be transmitted. It should be noted that reservations for the workshop are not essential. For example, a user may make a reservation for a workshop via the user terminal 20.

In S111, the control unit 300 outputs to the user terminal 20 information about the factory where the reservation has been completed. At this time, information on the name, address, and telephone number of the factory, for example, may be transmitted to the user terminal 20 as information on the work factory. In addition, information about the reservation date and time and the fee to be paid may also be output together. In addition, when the user himself/herself makes a reservation as described above, only the information regarding the workshop may be output. The control unit 300 may transmit to the user terminal 20 a command to display the information on the display 25 of the user terminal 20. Then, in S112, the control unit 300 orders the parts corresponding to the item by outputting the work factory to the terminal that manages the parts. Parts corresponding to items are associated with numbers stored in the item information DB 312, for example. A terminal for managing parts may be a terminal of a parts manufacturer. Ordering parts is not essential. For example, the factory server 40 may order parts according to the reservation.

As described above, according to the present embodiment, it is possible to determine the factory that provides the service of adding items to the vehicle 10 depending on whether the vehicle 10 has a structure corresponding to the item. Therefore, suitable factories that can add retrofit items can be presented. In this manner, the user can be notified of the factory where the work is to be performed, making it easier for the user to visit the factory. In addition, since the factory where the work is to be performed is automatically reserved, the user does not need to make a separate reservation. In addition, since the parts related to the item are delivered to the factory where the work is performed, there is no need for the worker or user to separately order the parts.

### Other Embodiments

The above-described embodiments are merely examples, and the present disclosure may be appropriately modified and implemented without departing from the scope thereof. The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, the center server 30 may have some or all of the functions of the factory server 40. Also, for example, the factory server 40 may have some or all of the functions of the center server 30. Also, the vehicle 10 may have some or all of the functions of the user terminal 20.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit that executes:
acquiring a request for adding an item to a vehicle;
acquiring first information that is information according to whether the vehicle has a structure for adding the item;
determining a factory that provides a service for adding the item to the vehicle based on the first information and information about the item; and
outputting information about the factory.

2. The information processing device according to claim 1, wherein the control unit orders a part related to the item such that the item is delivered to the factory.

3. The information processing device according to claim 1, wherein the control unit transmits a command for displaying the information about the factory on a display of a terminal of a user of the vehicle.

4. The information processing device according to claim 1, wherein the control unit acquires information about dates and times available for reservation at the factory, and reserves a date and time specified by a user among the dates and times available for the reservation.

5. The information processing device according to claim 1, wherein the information according to whether the vehicle has a structure for adding the item includes information regarding whether a wire harness connectable to the item is attached to the vehicle.
